(19) United States
(12) Patent Application Publication
(10) Pub. No.: US 2014/0106857 A1
(43) Pub. Date: Apr. 17, 2014

(54) BETTING SYSTEM AND METHOD OF BETTING

(71) Applicants: Richard A. Herbert, Riverside, IL (US); William T. Geoghegan, Las Vegas, NV (US)

(72) Inventors: Richard A. Herbert, Riverside, IL (US); William T. Geoghegan, Las Vegas, NV (US)

(21) Appl. No.: 14/024,213

(22) Filed: Sep. 11, 2013

Related U.S. Application Data
(60) Provisional application No. 61/699,525, filed on Sep. 11, 2012.

(51) Int. Cl. G07F 17/32

(52) U.S. Cl. CPC G07F 17/3288
USPC 463/25

(57) ABSTRACT

A betting system with a processor that receives a wagering input from a user and in response to the wagering input randomly generates different outcomes with: a) different probabilities; and b) no payout or different payouts. The processor triggers a bonus round based on one or more of the outcomes generated. A first display area at which first information, including at least some of the outcomes generated in response to the wagering input, is viewable by a user. The first information remains viewable by a user while a user is participating in the bonus round. The processor is configured so that a user can continue to make wagering inputs to the processor without terminating the bonus round, once triggered, and view the first information at the first display area while participating in the bonus round.

### CROSS-REFERENCE TO RELATED APPLICATIONS

This application claims the benefit of the filing date of U.S. Provisional Ser. No. 61/699,525, filed Sep. 11, 2012, which is hereby incorporated by reference in its entirety.

### BACKGROUND OF THE INVENTION

1. Field of the Invention

This invention relates to betting systems that randomly generate different outcomes based upon wagering inputs and, more particularly, to a betting system that, in response to certain wagering inputs, triggers a bonus round. The invention relates also to a method of betting.

2. Background Art

As used herein, a “betting system” encompasses at least systems with processors made with formats identified as any of: a) fixed odds slots; b) pari-mutuel; and c) historical racing.

Current betting systems utilize extensive “bonus rounds” to entertain the users as part of the ‘time on the machine” paradigm used in today's fixed odds slot industry to draw patrons to play high percentage hold video slot machines. Because fixed odds video penny slots typically have a hold percentage of 13-14% (outside of Las Vegas), the industry provides the player with high entertainment value video animation and sound effects—concentrated in bonus rounds—in exchange for the high hold percentage. The most vital part of the video entertainment is extensive bonus round animation intervals that take over the video monitor and may take 30 seconds to three or more minutes to play out. Often this animation in the bonus round requires very active participation and concentration from the player. While this serves the purpose of entertaining the player, it does so at a cost. It might cut out, in one hour of play, many minutes where the player is not betting credits but is instead “playing” the bonus round. In an hour, bonus animation being “played” by the player may take up over eight minutes of time. Since the player does not bet money during this time, much potential revenue is lost. An average 1¢ video slot player makes eight bets per minute with a bet value averaging 70¢. This equates to $5.60 of play per minute or $44.80 per hour. Using a hold percentage of 13-14%, some $6.05 of theoretic profit is lost per player per hour. If a venue has 300 players average playing twenty hours per day, then $35,300 of profit per day could be lost—over $13,250,000 of lost profit in a year. In a state with ten such venues, the lost profits might total over $132,500,000 in a year.

### SUMMARY OF THE INVENTION

In one form, the invention is directed to a betting system having a processor that receives a wagering input from a user and in response to the wagering input randomly generates different outcomes with: a) different probabilities; and b) no payout or different payouts. The processor triggers a bonus round based on one or more of the outcomes generated. A monitor has a first display area at which first information, including at least some of the outcomes generated in response to the wagering input, is viewable by a user. The first information remains viewable by a user while a user is participating in the bonus round. The processor is configured so that a user can continue to make wagering inputs to the processor without terminating the bonus round, once triggered, and view the first information at the first display area while participating in the bonus round.

In one form, a second display area is provided at which second information relating to the bonus round is viewable by a user with the first information remaining viewable at the first display area and the processor functional for receiving continued wagering inputs by a user.

In one form, the first and second display areas are on separate monitors.

In one form, the first and second display areas are on a single monitor with an overall display area divided into the first and second display areas.

In one form, the first display area changes in at least one of: a) location; b) size; and c) shape as an incident of the bonus round being triggered.

In one form, the first display area remains unchanged in terms of size, location, or shape once the bonus round is triggered.

In one form, the processor is configured so that a wagering input to the processor during a bonus round triggers a second bonus round. Third information relating to the second bonus round is viewable by a user at a third display area. The third display area is viewable at the same time that the first and second information remains viewable.

In one form, the processor is made with a fixed odds slot format.

In one form, the processor is made with a pari-mutuel wagering format.

In one form, the processor is made with an historical racing format.

In one form, the processor and first display area are integrated into a housing.

In one form, the processor and at least one display monitor are integrated into a housing. The at least one display monitor defines the first and second display areas.

In one form, the invention is directed to a method of betting including the steps of: a) using a betting system with a processor that receives a wagering input from a user and in response to the wagering input randomly generates different outcomes with: i) different probabilities; and ii) no payout or different payouts, the processor configured to trigger a bonus round based on one or more of the outcomes generated; b) making at least one wagering input to the processor and thereby causing the processor to cause: i) generation of first viewable information including one outcome; and ii) triggering of a bonus round; and c) while the bonus round is progressing, making another wagering input.

In one form, the step of making another wagering input involves causing the another wagering input to cause the processor to cause generation of viewable information, including an outcome generated in response to the another wagering input while the bonus round is progressing.

### BRIEF DESCRIPTION OF THE DRAWINGS

FIG. 1 is a perspective view of a conventional betting system with a single information display monitor and a single display area thereon;

FIG. 2 is a schematic representation of a betting system, according to the present invention, with separate information display areas;

FIG. 3 is one specific form of betting system as in FIG. 2 with separate display monitors defining the separate display areas for information;

FIG. 4 is a view as in FIG. 3 showing another form of the inventive betting system wherein a single display monitor is split to define separate display areas;

FIG. 5 is a schematic representation of a further modified form of display monitor, according to the invention, with multiple display areas; and

FIG. 6 is a flow diagram representation of a system for betting, according to the invention.

### DETAILED DESCRIPTION OF THE PREFERRED EMBODIMENT

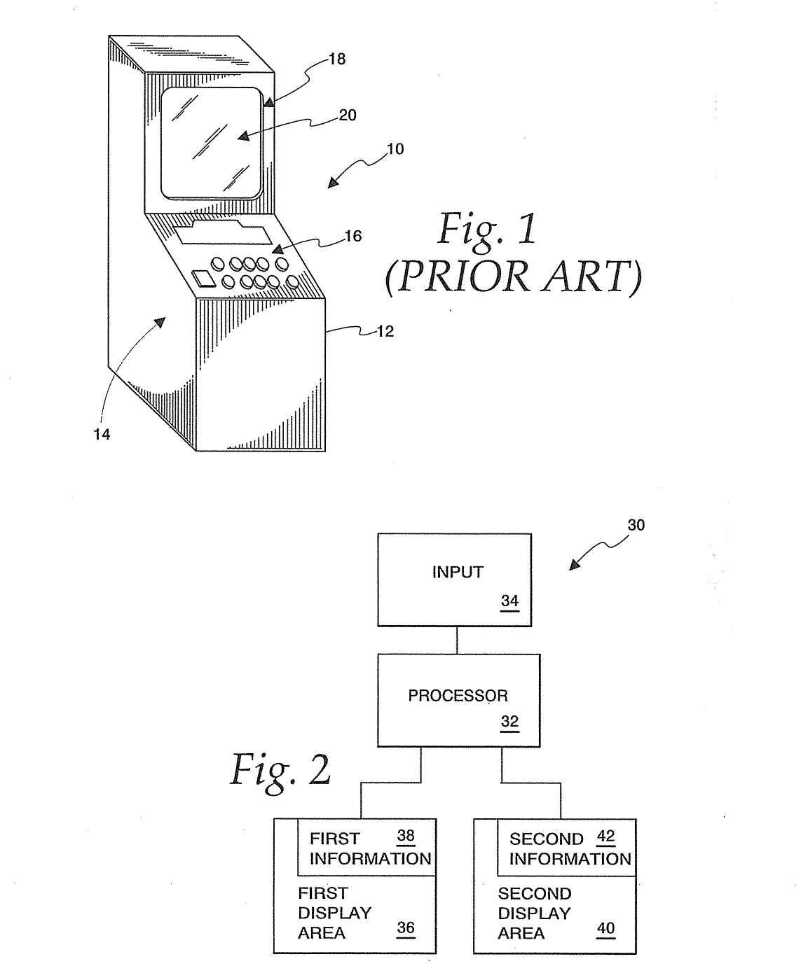

In FIG. 1, a prior art betting system is shown at 10. The system 10 consists of a housing 12 which contains a processor 14. A control panel at 16 allows for various user inputs, including a wagering input. The processor 14 may be made with any of: a) a fixed odds slot format; b) a pari-mutuel wagering format; or c) an historical racing format. A monitor at 18 has a single display area 20 at which information concerning the particular game being played is viewable by a user. Once a wagering input is received, the processor 14 randomly generates one of many possible outcomes to which the displayed information relates.

The processor 14 is configured to cause a bonus round to be triggered in response to a particular outcome. As an incident thereof, the display area 20 on the monitor 18 converts to display information concerning the bonus round, which typically involves an entertaining interlude where prize money is awarded. This precludes concurrent play—where credits (money) are wagered through wagering inputs—while this bonus video plays out, often with active participation of the user making choices, selecting options and taking action, etc., but not betting money.

As shown schematically in FIG. 2, the inventive betting system 30 consists of a processor 32 that receives a wagering input 34 from a user. In response to the inputs 34, the processor 32 randomly generates different outcomes with: a) different probabilities; and b) no payout or different payouts. A first display area 36 is provided at which first information 38, including at least some of the outcomes generated in response to the wagering input 34, is viewable by a user.

A second display area 40 is provided at which second information 42 is viewable by a user. The first information 38 remains viewable by a user while the user is participating in the bonus round. The processor 32 is configured so that a user can continue to make wagering inputs to the processor 32 without terminating the bonus round, once triggered, and view the first information 38 at the first display area 36 while participating in the bonus round. In other words, the processor 32 remains functional for receiving continued wagering inputs 34 and ongoing displaying of the first information while the user participates in the bonus round.

The schematic showing in FIG. 2 is intended to encompass the specific embodiments disclosed herein as well as embodiments with virtually an unlimited number of variations thereto that would be obvious to one skilled in the art with the present invention in hand.

The separate display areas 36, 40 allow the user to passively watch the bonus round while actively playing and betting the regular game. Of course, the user's attention will be somewhat divided between normal play and bonus play and full recovery of the lost potential revenue might not be realized. But a good deal will be, and bonus rounds can be designed to require less user active participation. A more passive bonus round experience can be designed that would allow the user to maintain most of his/her focus on regular game play with credit betting being maintained.

In the example of fixed odds slots when a bonus round was triggered, play of the regular game would continue as usual, with the related information 38 viewable at the first area 36 with the bonus play information 42 viewable at the same time at the second display area 40. As an example of how play might proceed: in the time period while a bonus round is taking place, and the user is actively betting the regular game simultaneously, the fixed odds device (of course, this would apply for historical racing devices also) might utilize an algorithm whereby the simultaneous betting while a bonus round is taking place triggers the utilization or “appropriating” of some of the bonus round money destined to be paid out in the instant bonus round over to a now second bonus round (triggered by the user's behavior of betting the regular game while the first bonus round is taking place). In such a manner a user would be “encouraged” to bet while a bonus round is taking place. Such positive user reinforcement to keep betting is but one example of how this methodology can be exploited to increase play.

Such a scenario would supply users with intense entertainment and would “make up” to the user for his/her not taking active participation in the actual active playing of bonus rounds. Perhaps 50-60% of the lost bonus round revenue could be made up for by this methodology without significant, if any, loss of entertainment value to the user.

In an historical racing format, e.g., Herbert U.S. Pat. Nos. 5,888,136 and 6,152,822, the disclosure of which is incorporated by reference, where “residual payments” complete the pari-mutuel process (at the close of a wagering pool), bonus rounds are the mechanism to pay residual payments both in mid and end pool sequences. The user (like in the above application to fixed odds slots) can also be “encouraged” to participate in the regular game (taking place simultaneously with the ongoing bonus round) by purposeful payments that trigger a second simultaneous bonus round to reinforce the user's continued betting while bonus rounds are taking place. Such a scenario would also add to the user's entertainment and partially or fully make up to the user for not being able to actively play a bonus round. This moving a user to continue playing is not radical as one sees many individuals today simultaneously playing two slot machines. This configuration would allow for increased play, more entertaining events—at least more events—and more revenue without adversely affecting bonus round entertainment.

For this methodology to be fully effective, preferably there is no connection between the two monitors or the two areas of the one monitor displaying both regular play and bonus round play. The reason is that if a user's input to the regular game has effect on the bonus round screen, the user will naturally focus attention to the bonus round screen and decrease credit plays into the regular game during this time. This defeats the purpose of the methodology. Ideally, the user would pay attention to betting the regular game. Some harmless effects that take place from user action on the regular screen and appear on the bonus round's screen, but don't require player attention to actively play, might be allowed. The displayed bonus round activity should be almost completely passive, entertaining, and not be requiring of user active input. It should be a secondary focus for the user.

For historical racing formats, the use is essentially identical as exampled for fixed odds devices. During bonus rounds, historical racing provides ample funding from residual payments used to complete pari-mutuel payouts. In fact, in historical racing, the bonus round funding amounts are more precisely known than for fixed odds devices where some bonus rounds involve additional random number generator determinations that could leave little or no prize money to fund added bonus rounds. A user could get an added bonus round in a fixed odds slot meant to encourage his/her betting during regular game play and yet, due to chance events on the random number generator trial, win nothing. In historical racing, the residual payments, while not precisely known until a pool closes, are known to a high degree—enough to reliably fuel a second bonus round used to encourage users to bet in the regular game while a bonus round is simultaneously taking place.

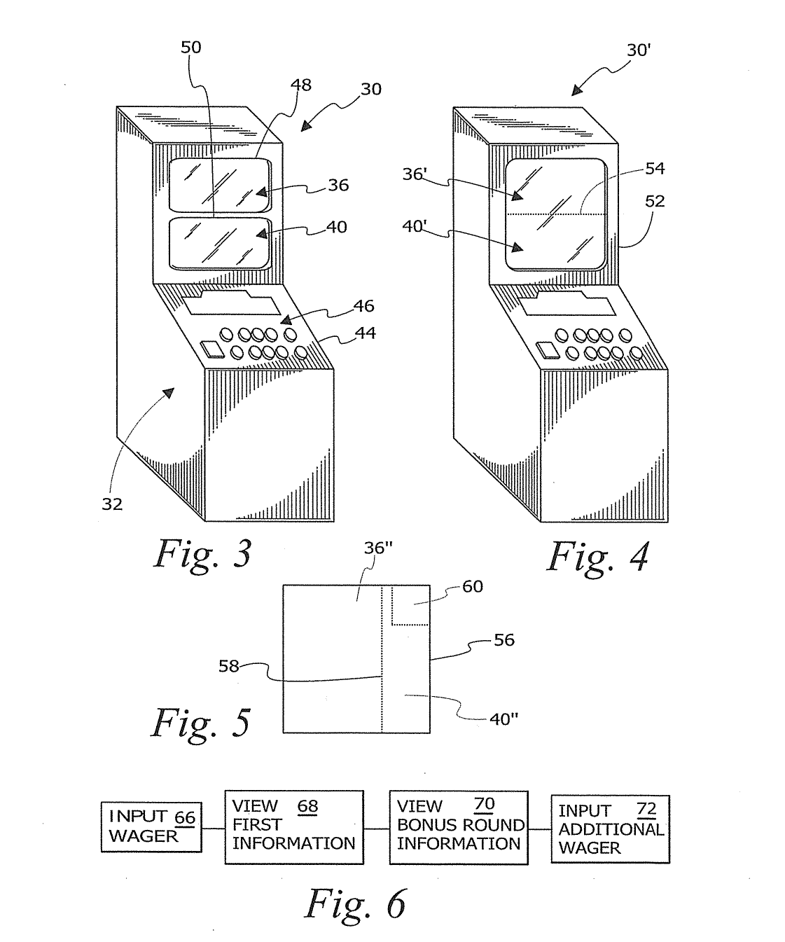

The invention contemplates virtually an unlimited number of manners of creating the first and second display areas 36, 40 per the schematic showing in FIG. 2. In FIG. 3, one specific form of the betting system is shown at 30, with the processor 32 incorporated into a housing 44. A control panel at 46 allows a user to operate the betting system, including inputting a wager, and playing a bonus round. In this embodiment, the first display area 36 and second display area 40 are provided on separate monitors 48, 50, respectively.

In FIG. 4, a modified form of betting system is shown at 30′, with the primary distinction lying in the fact that the separate display areas 36′, 40′ are provided on a single monitor 52 that is split either at all times or upon triggering of the bonus round. A dividing line 54 is shown that digitally splits the overall display area into the separate display areas 36′, 40′.

The invention contemplates that the first display area might at all times remain unchanged in terms of size, location, and shape, once the bonus round is triggered.

Alternatively, the first display area may change in at least one of location, size, and shape as an incident of the bonus round being triggered. For example, as shown on the monitor 56 in FIG. 5, the first display area may occupy the entire area of the monitor 56. Upon triggering of the bonus round, the first display area 36″ may be digitally altered so as to be reduced in size and shape, as indicated by the outline in dotted lines 58. The second display area 40″ may occupy the remainder of the overall display area on the monitor 56.

The first display area does not have to be on the same monitor and might be shifted to another monitor at another location. What is important is the ability to simultaneously view the information associated with the primary game and the bonus round.

As noted above, the processor 32 may be configured so that a wagering input to the processor 32 during a bonus round triggers a second bonus round with third information relating to the second bonus round that is viewable by a user at a third digitally created display area at 60, shown within the second display area 40″ in FIG. 5. This location is not intended to be limiting. Serial triggering of additional bonus rounds is also contemplated.

With the structure described above, betting can take place as described in flow diagram form in FIG. 6. More specifically, as shown in block 66, a user inputs a wager. As shown at block 68, the user views first information including an outcome generated in response to the wagering input. As shown at block 70, with a bonus round triggered, the user views bonus round information. As shown at block 72, while the bonus round is progressing, the user inputs an additional wager.

Regardless of how the information from the bonus round and that generated in response to the wagering input are displayed, the user has the ability to continue inputting wagers while the bonus round progresses.

The foregoing disclosure of specific embodiments is intended to be illustrative of the broad concepts comprehended by the invention.

1. A betting system comprising:
a processor that receives a wagering input from a user and in response to the wagering input randomly generates different outcomes with: a) different probabilities; and b) no payout or different payouts,
the processor triggering a bonus round based on one or more of the outcomes generated; and
a first display area at which first information including at least some of the outcomes generated in response to the wagering input is viewable by a user,
the first information remaining viewable by a user while a user is participating in the bonus round,
the processor configured so that a user can continue to make wagering inputs to the processor without terminating the bonus round once triggered and view the first information at the first display area while participating in the bonus round.

2. The betting system according to claim 1 further comprising a second display area at which second information relating to the bonus round is viewable by a user with the first information remaining viewable at the first display area and the processor functional for receiving continued wagering inputs by a user.

3. The betting system according to claim 2 wherein the first and second display areas are on separate monitors.

4. The betting system according to claim 2 wherein the first and second display areas are on a single monitor with an overall display area divided into the first and second display areas.

5. The betting system according to claim 2 wherein the first display area changes in at least one of: a) location; b) size; and c) shape as an incident of the bonus round being triggered.

6. The betting system according to claim 2 wherein the first display area remains unchanged in terms of size, location, or shape once the bonus round is triggered.

7. The betting system according to claim 1 wherein the processor is configured so that a wagering input to the processor during a bonus round triggers a second bonus round and third information relating to the second bonus round is viewable by a user at a third display area, the third display area viewable at the same time that the first and second information remains viewable.

8. The betting system according to claim 1 wherein the processor is made with a fixed odds slot format.

9. The betting system according to claim 1 wherein the processor is made with a pari-mutuel wagering format.

10. The betting system according to claim 1 wherein the processor is made with an historical racing format.

11. The betting system according to claim 1 wherein the processor and first display area are integrated into a housing.

12. The betting system according to claim 2 wherein the processor and at least one display monitor are integrated into a housing, the at least one display monitor defining the first and second display areas.

13. A method of betting comprising the steps of:
using a betting system comprising a processor that receives a wagering input from a user and in response to the wagering input randomly generates different outcomes with: a) different probabilities; and b) no payout or different payouts,
the processor configured to trigger a bonus round based on one or more of the outcomes generated,
making at least one wagering input to the processor and thereby causing the processor to cause: a) generation of first viewable information including one outcome; and b) triggering of a bonus round; and
while the bonus round is progressing, making another wagering input to the processor.

14. The method of betting according to claim 13 wherein the step of making another wagering input comprises causing the another wagering input to cause the processor to cause generation of viewable information including an outcome generated in response to the another wagering input while the bonus round is progressing.
